(19) United States
(12) Patent Application Publication
(10) Pub. No.: US 2018/0025308 A1
(43) Pub. Date: Jan. 25, 2018

(54) SOCIO-TECHNICAL SYSTEM FOR RAPID VALUE CREATION IN AN ENTERPRISE

(71) Applicant: International Business Machines Corporation, Armonk, NY (US)

(72) Inventors: Pritpal S. Arora, Bangalore (IN); Bijo S. Kappen, Bangalore (IN); Gopal S. Pingali, Mohegan Lake, NY (US); Adinarayana Sakala, Tirupati (IN)

(21) Appl. No.: 15/215,715

(22) Filed: Jul. 21, 2016

(51) Int. Cl. G06Q 10/06; G06Q 30/02

(52) U.S. Cl. CPC G06Q 10/063112; G06Q 10/06398; G06Q 10/06313; G06Q 30/0208

(57) ABSTRACT

A system, method and program product for providing an enterprise rapid value generation (ERVG) system A system is provided having: an opportunity processor that provides an interface for specifying an opportunity within an enterprise, wherein the opportunity includes an associated proposal having: a requirements statement, a timeframe, an enterprise value, and reward parameters; a contributor selection system that notifies target contributors of the opportunity over a network and creates a team of contributors; a contribution manager that tracks and validates contributions from the team of contributors towards a solution; and a rewards system that calculates a reward for each member of the team of contributors based on validation of a contribution and an amount of time in which the contribution was completed.

### TECHNICAL FIELD

The subject matter of this invention relates to creating value in an enterprise, and more particularly to a socio-technical system and method of automating value generation in an enterprise.

### BACKGROUND

Enterprises often lack effective mechanisms to solve a problem or create new value. A large reason is that it takes too long to create awareness of a problem or an opportunity among the people who could do something about it, to motivate these people to address the problem or opportunity, to effectively bring together the different ideas and approaches from different people into an effective solution for the problem or opportunity at hand, to validate the solution, and to get the validated solution to relevant stakeholders. This results in loss of time and money for the enterprise, loss of competitiveness, lost opportunities, and sub-optimal leverage of expertise within the enterprise.

Current approaches for such initiatives broadly fall under the categories of: (a) management or organization driven; (b) grass-roots innovation driven by employees; (c) a hybrid of grass-roots and management driven approaches where employee innovation graduates to management blessed initiatives, and (d) reaching out to others in the enterprise and sometimes to external sources to address a problem or an opportunity.

Each of these is limited due to the inability to bring the best relevant expertise to address the problem or opportunity at hand in a motivated fashion, to effectively pull together contributions from different people into a coherent solution, to effectively reward such contributions, and to converge on a solution with high speed. For example, (a) management or organization driven approaches are typically restricted within their group, not finding all relevant expertise in the enterprise, and any reward system is typically through performance evaluations and specific awards, not sufficiently driving bottom-up innovation; (b) grass-roots innovation driven by employees cannot necessarily address urgent problems or challenges, lack the urgency needed to address an issue, provide insufficient reach to all relevant expertise to address an identified issue, and lack an effective reward system for progress and results; (c) a hybrid of grass-roots and management driven approaches likewise are limited in bringing all relevant expertise to address the issue, lack adaptation and speed of response to newly emerging challenges and issues; and (d) reaching out to others to solve a problem happens in an ad-hoc manner in which those helping get insufficient recognition, resulting in insufficient motivation to reach a solution with speed.

### SUMMARY

Aspects of the disclosure provide a socio-technical platform for rapid value creation in an enterprise that enables anyone in the enterprise to identify an opportunity, estimate a value for the enterprise, propose a reward structure, and set forth a timeframe to address the opportunity. The platform automatically: obtains authorization for the opportunity, establishes a value and finalizes reward parameters; broadcasts the opportunity to relevant people across the enterprise; enables people notified of an opportunity to refer others; collects and tracks contributions from participants; filters and validates contributions; determines if a viable solution to the opportunity has been found; computes a temporal reward for an identified solution; propagates and distributes the reward across direct and indirect contributors to the solution; and automatically updates a score of the contributors in performance rating systems in the enterprise.

The platform also provides the ability to automatically identify potential opportunities from existing databases in the enterprise.

A first aspect discloses an enterprise rapid value generation (ERVG) system, comprising: an opportunity processor that provides an interface for specifying an opportunity for an enterprise, wherein the opportunity is defined by an associated proposal that includes: a requirements statement, a timeframe, an enterprise value, and reward parameters; a contributor selection system that notifies target contributors of the opportunity via a network and creates a team of contributors; a contribution manager that tracks and validates contributions from the team of contributors towards a solution; and a rewards system that calculates a reward for each member of the team of contributors based on validation of a contribution and an amount of time in which the contribution was completed.

A second aspect discloses a computer program product stored on a computer readable storage medium, which when executed by a computing system, provides a rapid value generation platform, the program product comprising: program code that provides an interface for specifying an opportunity for an enterprise, wherein the opportunity is defined by an associated proposal having: a requirements statement, a timeframe, an enterprise value, and reward parameters; program code that notifies target contributors of the opportunity over a network and assembles a team of contributors; program code that tracks and validates contributions from the team of contributors towards a solution; and program code that calculates a reward for each member of the team of contributors based on validation of a contribution and an amount of time in which the contribution was completed.

A third aspect discloses a computerized method that provides a platform for enterprise rapid value generation, comprising: providing an interface for specifying an opportunity for an enterprise, wherein the opportunity is defined by an associated proposal having: a requirements statement, a timeframe, an enterprise value, and reward parameters; notifying target contributors of the opportunity over a network; assembling a team of contributors; tracking and validating contributions from the team of contributors towards a solution; and calculating a reward for each member of the team of contributors based on validation of a contribution and an amount of time in which the contribution was completed.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having an enterprise rapid value generation system according to embodiments.

FIG. 2 shows a flow of an enterprise rapid value generation system according to embodiments.

FIG. 3 shows a flow of a rewards process according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

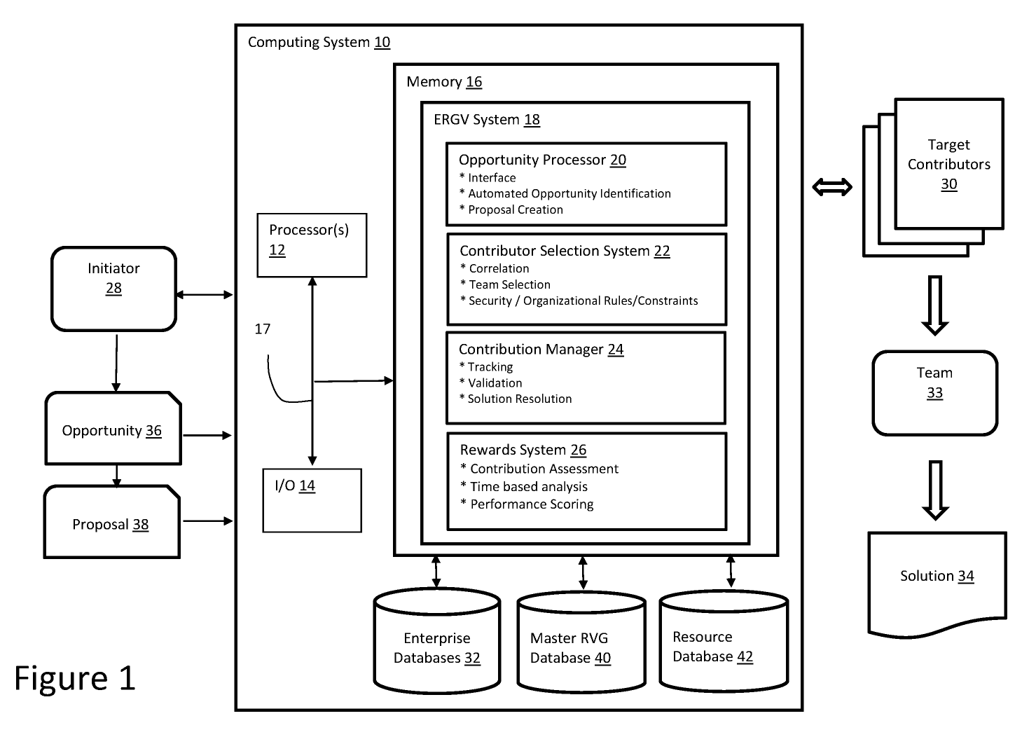

Referring now to the drawings, FIG. 1 depicts a computing system 10 having an enterprise rapid value generator (ERVG) system 18 for facilitating the provisioning of a solution 34 for an enterprise based on an opportunity 36 specified by an initiator 28. An opportunity 36 may comprise anything that can potentially add value, reduce cost, or solve a problem for the enterprise. For example, the enterprise may have a database of Request for Proposals (RFPs) that have not been addressed but could result in new business; the initiator 28 may come across a technical problem that is impacting products sold by the enterprise; the initiator 28 might recognize the need for some new technology to improve efficiency, etc. Regardless, using the ERVG system 18, the initiator 28 is able to leverage disparate resources from within the enterprise to provision a solution 34 to address the specified opportunity 36.

On the front end, ERVG system 18 includes an opportunity processor 20 to define, store, evaluate, authorize and process a specified opportunity 36. Opportunity processor 20 includes an interface that allows the initiator 28 to specify an opportunity 36 for the enterprise either based on recognized needs or motivation and/or based on information extracted from various enterprise databases 32. Illustrative databases 32 from which an opportunity 36 may be extracted include, e.g., deals databases, sales databases, knowledge databases, problem databases, opportunity databases, etc.

Opportunities 36 may be specified via any type of computerized interface, e.g., using menu driven selections, via a natural language (NL) dialog, using drop down boxes, etc. Opportunities may be specified using structured or unstructured data. For example, initiator 28 may type a NL string into an interface such as “I just learned of an RFP for designing and building a data warehouse for a large retailer, but need help responding.” In a further example, initiator 28 may utter an NL command “tell me all of the known RFPs involving data warehouses.” In still a further example, the initiator may request help troubleshooting a technical issue using a menu driven graphical user interface. Once initiated, opportunity processor 20 guides the initiator 28 to further define the opportunity 36 with the creation of a proposal 38.

Specifically, opportunity processor 20 may engage the initiator 28 with a computerized dialog to define a set of parameters for a proposal 38. Such parameters generally include: (a) a requirements statement that provides all necessary details of the opportunity, implementation requirements, and a specified solution; (b) a timeframe in which the solution is required; (c) a value or benefit the enterprise will receive; and (d) reward parameters for those contributing to the solution 34. Once defined, proposal 38 is stored in a master rapid value generator (RVG) database 40. For example, an opportunity may be stored as follows:

<Opportunity Title> Data Warehouse RFP

<Proposal Parameters> P1

<Requirements Statement>

<Overview> “Preparation and submission of a response

to an RFP for a data warehouse”

<Authorization level> L5
<Solution Components> Budget, timeline, experience
<Requirements> Security, Location

<Time Frame> 4 weeks
<Potential Value> $250 million
<Rewards Parameters> $25,000 to be split among contributors

In preparing and formalizing the proposal 38, opportunity processor 20 may utilize automated processes for identifying and refining the opportunity 36 into a set of components. Automated processes may evaluate a problem statement into a structured format, determine a more specific value for the enterprise, determine timing requirements for completion of components of a solution 34, and further structure rewards parameters. Once formalized, the proposal 38 is initially vetted to assess viability, check authorizations, and determine if the opportunity 36 has already been addressed and a solution 34 exists.

Also included in ERVG system 18 is a contributor selection system 22 that broadcasts a notification of the opportunity 36 or component of the opportunity 36 to one or more sets of target contributors 30 via a computer network, analyzes responses, and forms a team 33 (one or more) of contributors. Identification of target contributors 30 may be facilitated with one or more resource databases 42 including a user directory database, a skills and experiences database, an employee performance database, etc. Target contributors 36 may accept or decline the invitation to participate, e.g., by responding to an email, text, etc. Target contributors 30 may also forward or “refer” the opportunity 36 to others who might be a good fit on the team 33 of contributors. Defining the opportunity requirements and selecting a team 33 may be further facilitated by a correlation process that searches for related opportunities previously addressed to identify experts or individuals with relevant experiences. Various rules may be applied to the selection process, including rules that enforce security and/or organizational constraints associated with team members. For example, a particular opportunity may require contributors with a certain security clearance or geographic locations.

Once a team 33 of contributors has been selected, a contribution manager 24 is utilized to track and manage the solution 34 as the solution 34 is implemented, including tracking contributions of different team members, validating contributions, and ensuring that any resulting solution 34 or components thereof resolves the requirements defined by the proposal 38.

Finally, a rewards system 26 is provided that establishes and provides rewards to those who contributed to the solution 34 and those who provided referrals. In addition, rewards system 26 may forward information about contributions into an employee performance database that can be used for employee reviews.

Accordingly, anyone in the enterprise can specify an opportunity 36 and formulate a proposal 38. Once the proposal parameters such as requirements, timing, value, reward, etc., are established and approved, the described socio-technical system for rapid value creation is automatically launched. The ERVG system 18 first ensures the right level of enterprise authorization is obtained for the established value and reward parameters and then it automatically broadcasts the opportunity across the enterprise (and selectively outside the enterprise), in compliance with any enterprise security and constraints.

Once broadcast, target contributors 30 notified of the opportunity 36 can refer the opportunity 36 to other people who could add value. ERVG system 18 keeps track, filters and validates suggestions and contributions, and determines if and when a viable solution 34 to the opportunity has been achieved. Once achieved, rewards are distributed to contributors.

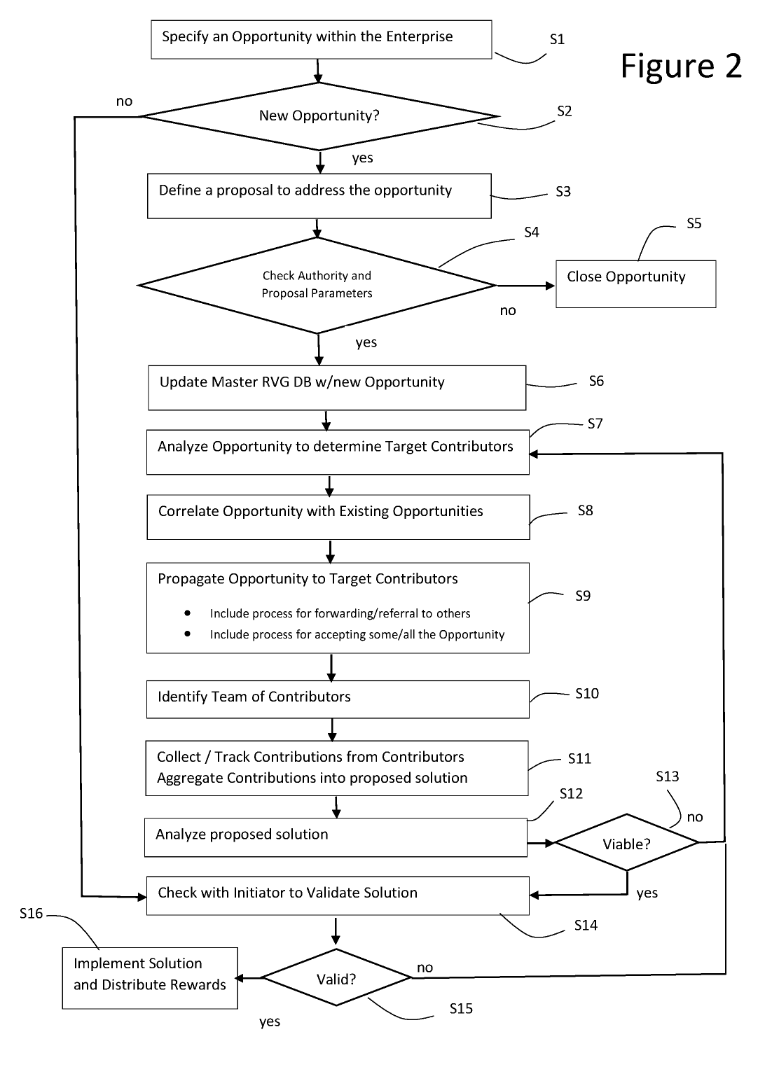

FIG. 2 depicts a more detailed flow and overview of the process of ERVG system 18 of FIG. 1. At S1, an initiator 28 within the enterprise specifies an opportunity 36. Specification of the opportunity 36 as noted may be done by interacting with an interface to select from existing opportunities or propose a new opportunity. Existing opportunities may reside in an opportunity database or be extracted dynamically from other existing enterprise databases 32. Proposing a new opportunity 36 may result from a personal experience or need of the initiator 28.

For example, the initiator 28 may become aware of a sales opportunity to provide data warehousing services for a major online retailer. In order to address the opportunity, the enterprise will need to provide an initial submission to an RFP by a target date with components including a budget, experience, time line, sub-contractors, etc.

At S2, a determination is made whether any similar opportunities have already been addressed (e.g., based on keyword searching of known opportunities, etc.). If a similar opportunity has already been addressed, a determination is made at S14 and S15 whether the existing solution is valid for the current opportunity 36. If the opportunity 36 has not yet been addressed, then the initiator 28 can move forward and further define a proposal 38 at S4. As noted, the proposal 38 has various parameters, including: a requirements statement; an enterprise value (e.g., $250 million project); time frame (e.g., submission due date); and reward parameters (e.g., $25k total for contributors should the enterprise ultimately obtain the contract); any verification criteria and verification experts (e.g., key milestones and the names of individuals who can verify that the submission was done correctly and timely made), etc.

Once submitted, a determination is made at S4 if the initiator 28 has authority relative to the opportunity 36 and whether the proposal's parameters are acceptable. If not, the opportunity 36 may simply be closed at S5, automatically modified, or returned to the initiator 28 for modification. If yes, the master RVG database 40 is updated with the new opportunity 36 including all of the established parameters at S6 in the associated proposal 38. Next, at S7, a rules engine is used to analyze and categorize the opportunity and to identify a set of target contributors 30. Target contributors 30 may for example be ascertained from an enterprise employee directory and skills database. The rules engine may be employed to ensure that any target contributors 30 adhere to: (1) user preferences; (2) any domain rules; (3) value based rules; (4) data security rules; (5) location rules; (6) time based rules; and (7) authority based rules.

For example, in the case where the opportunity involves preparation of a submission to an RFP, the opportunity may be categorized in an XML taxonomy as:

<Category> RFP

<Field> Data Warehousing

<Requirement> Initial Submission

<Component 1> Submission Due Date = 12.12.17
<Component 2> Budget
<Component 3> Timeline
<Component 4> Experience
<Component 5> Team

<Reward> 25000

From the XML taxonomy, target contributors 30 can be identified who have capabilities to address different components. For example, enterprise employees can be identified who have previously put together a budget to design and build data warehouses.

At S8, the opportunity 36 can be correlated and cross referenced with other previously addressed opportunities to further evaluate the opportunity and identify target contributors 30. For example, system 18 may check for other opportunities involving the data warehouses, or opportunities where budgeting is required.

Next, at S9, notification of the opportunity 36 is broadcast to a set of target contributors 30. This may involve the application of a rules engine for checking availability, security clearances, preferred channels, preferences and obtaining pre-approval from an authorizing party. The broadcast may be done via email, text messaging, internal networking, social media, etc., in order to alert relevant employees of the potential to participate in the opportunity 36. Target contributors 30 can in return indicate their interest to participate in the opportunity 36 by, e.g., responding to an email or text, interfacing with a mobile applications, etc. Each target contributor 30 can also pass or refer the opportunity to any other employee or external entity. A check can be made to determine if the referred employee or external entity is already notified; and if not, the system 18 checks authorization criteria and generates a notification.

At S10, a team of contributors is identified and selected to participate and at S11, the system 18 collects and/or tracks the participation and contributions of each participant towards the solution 34. Contributions can be continuously aggregated to form a proposed solution.

At S12, the proposed solution, or component thereof, is analyzed for viability. For example, when any contributor submits a solution component, e.g., a document, demo, architecture, instructions, program coding, etc., an analysis of the component against a set of rules or predetermined criteria, e.g., keywords, a basic test, etc., can be implemented. Using this analysis, a check can be made at S13 whether the proposed solution is viable (either piecemeal or as a whole). If it is not viable, logic can return to S7 to attempt to identify different target contributors 30 to fulfill the solution 34 or solution component. If the proposed solution appears viable, then the solution 34 is passed back to the initiator 28 at S14 to determine if the viable solution is valid at S15. If it is not valid, the logic can return to S7 to attempt to identify different target contributors 30 to fulfill the solution 34. If it is viable, then the solution 34 can be implemented and rewards can be distributed at S16.

The system 18 may compute a solution reward score based on validation, satisfaction rating of the initiator 28 and/or validation team, and time window in which the solution was completed. A time decay function may be utilized to ensure higher rewards for higher speed solution creation. For example, if a solution 34 is met in a first “early” timeframe, the reward value may be increased by a factor of 0.5, if met in a second “acceptable” timeframe, the reward value may be paid in full, if met in a third “late” timeframe, the reward may be decreased based on number of days late, etc. The system 18 determines the share of reward to all who contributed to the solution through a contribution calculation mechanism. In addition, a performance or human resources database may be updated with contribution scores of all solution contributors.

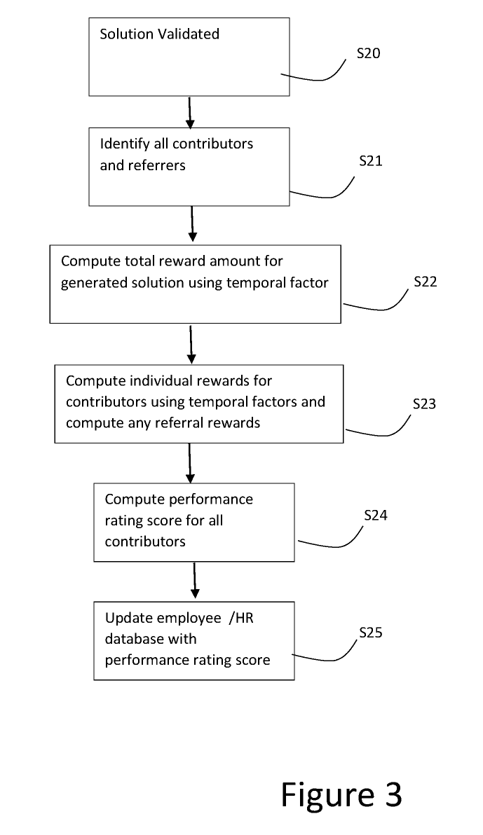

FIG. 3 depicts a flow showing a rewards process in response to a validated solution 34 at S20. At S21 all contributors are referrers are identified and at S22 a total reward amount for the solution is calculating using a temporal factor, resulting in a total reward value that depends on the speed at which the solution 34 was arrived at. At S23, rewards for individual contributors and referrers are calculated. Contributors are evaluated based on the nature of the component provided by a team member, and the successful and timely completion of the component. For example, a team member that did the bulk of the work for a solution and completed the task ahead of schedule would take a larger share of the total reward than a team member who completed a small task late.

At S24, a performance rating score may also be calculated for each contributor, e.g., on a scale of 1-10. The performance rating score may likewise be based on the nature of the component provided by a team member, and the successful and timely completion of the component. Once calculated, the performance scores can be fed to an employee/human resources database.

It is understood that ERVG system 18 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 10 that may comprise any type of computing device and for example includes at least one processor 12, memory 16, an input/output (I/O) 14 (e.g., one or more I/O interfaces and/or devices), and a communications pathway 17. In general, processor(s) 12 execute program code which is at least partially fixed in memory 16. While executing program code, processor(s) 12 can process data, which can result in reading and/or writing transformed data from/to memory and/or I/O 14 for further processing. The pathway 17 provides a communications link between each of the components in computing system 10. I/O 14 can comprise one or more human I/O devices, which enable a user to interact with computing system 10. Computing system 10 may also be implemented in a distributed manner such that different components reside in different physical locations.

Furthermore, it is understood that the ERVG system 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. An enterprise rapid value generation (ERVG) system, comprising:
an opportunity processor that provides an interface for specifying an opportunity for an enterprise, wherein the opportunity is defined by an associated proposal that includes: a requirements statement, a timeframe, an enterprise value, and reward parameters;
a contributor selection system that notifies target contributors of the opportunity via a network and assembles a team of contributors;
a contribution manager that tracks and validates contributions from the team of contributors towards a solution; and
a rewards system that calculates a reward for each member of the team of contributors based on validation of a contribution and an amount of time in which the contribution was completed.

2. The ERVG system of claim 1, wherein the opportunity processor includes a process for extracting opportunities from a set of enterprise databases selected from the group consisting of a sales database, a knowledge database, and a deals database.

3. The ERVG system of claim 1, wherein the contributor selection system analyzes the opportunity to identify target contributors.

4. The ERVG system of claim 1, wherein the contributor selection system correlates the opportunity with previously specified opportunities.

5. The ERVG system of claim 1, wherein the contributor selection system utilizes an employee directory and skills database to identify target contributors.

6. The ERVG system of claim 1, wherein the opportunity is stored in a master database.

7. The ERVG system of claim 1, wherein the reward system further assigns rewards for referring the opportunity.

8. A computer program product stored on a computer readable storage medium, which when executed by a computing system, provides a rapid value generation platform, the program product comprising:
program code that provides an interface for specifying an opportunity for an enterprise, wherein the opportunity is defined by an associated proposal having: a requirements statement, a timeframe, an enterprise value, and reward parameters;
program code that notifies target contributors of the opportunity over a network and assembles a team of contributors;
program code that tracks and validates contributions from the team of contributors towards a solution; and
program code that calculates a reward for each member of the team of contributors based on validation of a contribution and an amount of time in which the contribution was completed.

9. The program product of claim 8, wherein the interface includes a process for extracting opportunities from a set of enterprise databases selected from the group consisting of a sales database, a knowledge database, and a deals database.

10. The program product of claim 8, wherein the program code that notifies target contributors analyzes the opportunity to identify target contributors.

11. The program product of claim 8, further comprising program code that correlates the opportunity with previously specified opportunities.

12. The program product of claim 8, wherein the program code that notifies target contributors utilizes an employee directory and skills database to identify target contributors.

13. The program product of claim 8, wherein the opportunity is stored in a master database.

14. The program product of claim 8, wherein the program code that calculates a reward assigns rewards for referring the opportunity.

15. A computerized method that provides a platform for enterprise rapid value generation, comprising:
providing an interface for specifying an opportunity for an enterprise, wherein the opportunity is defined by an associated proposal having: a requirements statement, a timeframe, an enterprise value, and reward parameters;
notifying target contributors of the opportunity over a network;
assembling a team of contributors;
tracking and validating contributions from the team of contributors towards a solution; and
calculating a reward for each member of the team of contributors based on validation of a contribution and an amount of time in which the contribution was completed.

16. The computerized method of claim 15, wherein the interface includes a process for extracting opportunities from a set of enterprise databases selected from the group consisting of a sales database, a knowledge database, and a deals database.

17. The computerized method of claim 15, further comprising program code that correlates the opportunity with previously specified opportunities.

18. The computerized method of claim 15, wherein the program code that notifies target contributors utilizes an employee directory and skills database to identify target contributors.

19. The computerized method of claim 15, wherein the opportunity is stored in a master database.

20. The computerized method of claim 15, further comprising assigning rewards for referring the opportunity.
